(19) United States
(12) Patent Application Publication
(10) Pub. No.: US 2013/0102502 A1
(43) Pub. Date: Apr. 25, 2013

(54) BIO-CHIP

(71) Applicants: Jeong Suong YANG, Yongin (KR); Bo Sung Ku, Suwon (KR)

(72) Inventors: Jeong Suong YANG, Yongin (KR); Bo Sung Ku, Suwon (KR)

(73) Assignee: SAMSUNG ELECTRO-MECHANICS CO., LTD.

(21) Appl. No.: 13/358,252

(22) Filed: Jan. 25, 2012

(30) Foreign Application Priority Data
Oct. 25, 2011 (KR) 10-2011-0109183

(51) Int. Cl. C40B 60/14

(52) U.S. Cl. 506/40

(57) ABSTRACT

There is provided a bio-chip including a first substrate including a first recess formed in a first end surface thereof; and a second substrate including a first coupling pillar inserted into the first recess and a second coupling pillar in contact with a second end surface opposed to the first end surface.

### CROSS-REFERENCE TO RELATED APPLICATIONS

This application claims the priority of Korean Patent Application No. 10-2011-0109183 filed on Oct. 25, 2011, in the Korean Intellectual Property Office, the disclosure of which is incorporated herein by reference.

### BACKGROUND OF THE INVENTION

1. Field of the Invention

The present invention relates to a bio-chip and, more particularly, to a bio-chip in which a data chip and a meta-chip may be precisely bonded.

2. Description of the Related Art

Recently, the research and development of bio-technology for quickly diagnosing various diseases has been on the rise. In line with this trend, a bio-chip or a cell chip required for inspecting or checking a bio-material has been steadily developed.

A bio-chip or a cell chip, useful in inspecting a large quantity of bio-materials, can be used in a pharmaceutical and cosmetics companies, as well as in hospitals.

Meanwhile, in the pharmaceutical and cosmetics fields, a method of inspecting a reaction of cells to a particular medicine or cosmetic product to verify the validity and safety (toxicity) of the particular medicine or cosmetic product is in use, but existing methods require a great amount of reagents for a thorough examination, incurring high costs and requiring much time.

Thus, the development of a bio-chip able to save on costs and available for a rapid and precise diagnosis is required.

A bio-chip may be divided into a DNA chip, a protein chip, and a cell chip, according to types of bio-materials fixed to a substrate. Initially, DNA chips mainly emerged, in line with the increasing understanding of the genetic makeup of human beings, but gradually, as interests in proteins as the foundations of vital activities and cells as the backbone of living organisms, as corporate bodies of proteins, are increasing, a protein chip and a cell chip have become a major concern.

The development of a bio-chip capable of obtaining precise experiment results at low cost, irrespective of specific types of bio-materials, is required.

In particular, precise coupling of a data chip with a life cell cultivated therein and a meta-chip containing various chemical products or newly developed medicines is very critical to derive accurate inspection results, so the development of a bio-chip allowing the data chip and the meta-chip to be precisely coupled is urgently required.

### SUMMARY OF THE INVENTION

An aspect of the present invention provides a bio-chip allowing for a data chip and a meta-chip to be precisely coupled.

According to an aspect of the present invention, there is provided a bio-chip including: a first substrate including a first recess formed in a first end surface thereof; and a second substrate including a first coupling pillar inserted into the first recess and a second coupling pillar in contact with a second end surface opposed to the first end surface.

The first coupling pillar may have a conical shape, a pyramidal shape, a truncated conical shape, or a truncated pyramidal shape.

The second coupling pillar may have a conical shape, a pyramidal shape, a truncated conical shape, or a truncated pyramidal shape.

The first recess may have a section gradually reduced in a thicknesswise direction of the first substrate.

The second end surface may be a sloped face.

The first recess may gradually narrow from the first end surface toward the second end surface.

A distance from a radius center of the first recess to the second end surface may be greater than a distance from the first coupling pillar to the second coupling pillar.

The second end surface may include a second recess formed therein, and the second coupling pillar may be inserted into the second recess.

The second recess may have a section gradually reduced in the thicknesswise direction of the first substrate.

The second recess may gradually narrow from the second end surface toward the first end surface.

A distance from the radius center of the first recess to a radius center of the second recess may be greater than a distance from the first coupling pillar to the second coupling pillar.

The first substrate may include an accommodation recess accommodating a bio-material or medicine.

The second substrate may include a protrusion for fixing the bio-material or the medicine thereto.

The first or second substrate may be formed of a plastic material.

The first or second substrate may be formed of a hydrophilic material.

The first or second substrate may be formed of a hydrophobic material.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1 and 2 are perspective views of first and second substrates according to a first embodiment of the present invention;

FIGS. 3 and 4 are cross-sectional views showing a process of coupling the first and second substrates illustrated in FIGS. 1 and 2;

FIGS. 5 and 6 are perspective views of first and second substrates according to a second embodiment of the present invention;

FIGS. 7 and 8 are cross-sectional views showing a process of coupling the first and second substrates illustrated in FIGS. 5 and 6;

FIG. 9 is a perspective view of first and second substrates according to a third embodiment of the present invention;

FIGS. 10 and 11 are a cross-sectional view and a plan view showing a process of coupling the first and second substrates illustrated in FIG. 9;

FIGS. 12 and 13 are perspective views of first and second substrates according to a fourth embodiment of the present invention; and

FIGS. 14 and 15 are perspective views of first and second substrates according to a fifth embodiment of the present invention.

### DETAILED DESCRIPTION OF THE INVENTION

Hereinafter, embodiments of the present invention will be described in detail with reference to the accompanying drawings.

In describing the present invention below, terms indicating components of the present invention are named in consideration of functions of each component. Therefore, the terms should not be understood as being limited technical components of the present invention.

For reference, a meta-chip containing a chemical medicine or a developed new medicine may be a first substrate, and a data chip with a life cell cultivated therein may be a second substrate. However, the functions of the first and second substrates may be interchanged according to a life cell and a chemical medicine.

In addition, the first and second substrates used in the present embodiment are not particularly limited and may be formed of, for example, silicon, glass, metal, or polymer.

Types of polymers may include, for example, polymethylmethacrylate (PMMA), polycarbonate (PC), polystyrene (PS), polypropylene, cyclic olefin copolymer, polynorbonene, styrene-butadiene-copolymer (SBC), or acrylonitrile butadiene styrene, but the present invention is not limited thereto.

Also, a method for fabricating the first or second substrate is not particularly limited. For example, the first and second substrates may be fabricated through a photoresist process, an etching process, an injection-molding process, or the like.

In addition, a bio-material attached to or accommodated in the first or second substrate mentioned in the present disclosure refers to various materials including the bio-material, without being limited to the bio-material. For example a nucleic acid array such as RNA, DNA, or the like, peptide, protein, fat, an organic or inorganic chemical molecule, a virus particle, a prokaryotic cell, cell organelle, or the like, may be used instead of the bio-material. Also, the bio-material may be used to include various animal cells or plant cells, rather than being limited to human cells.

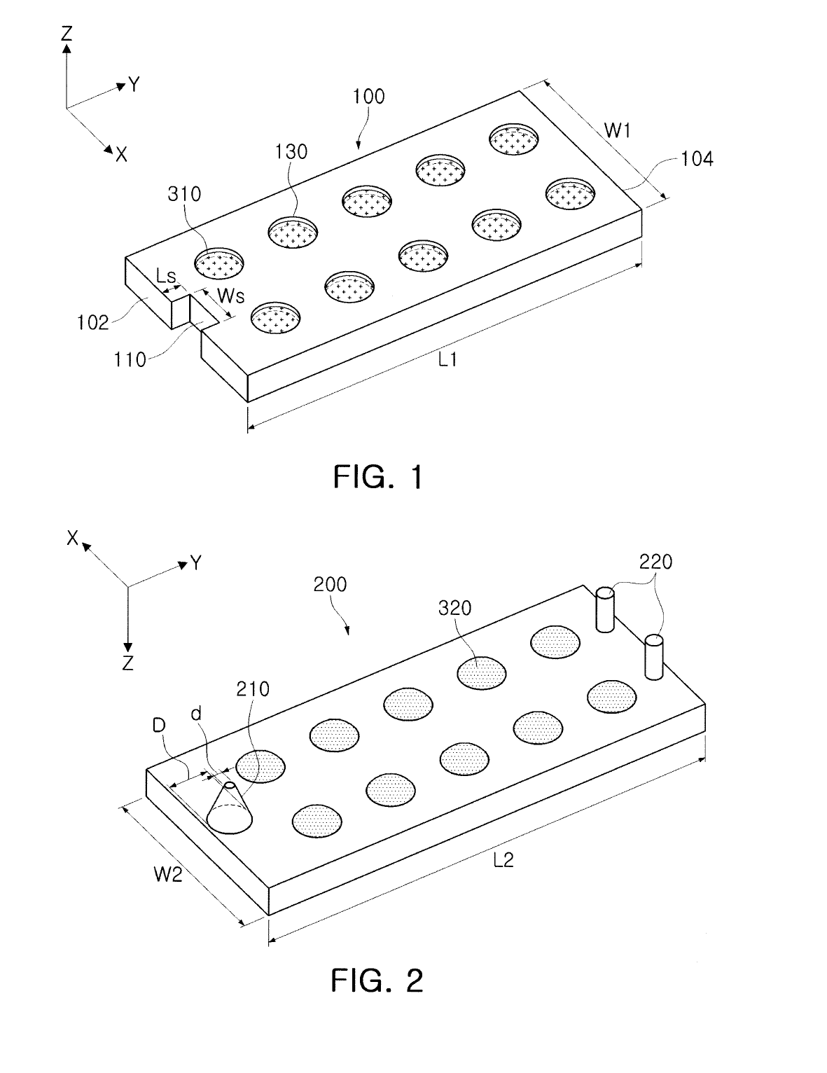

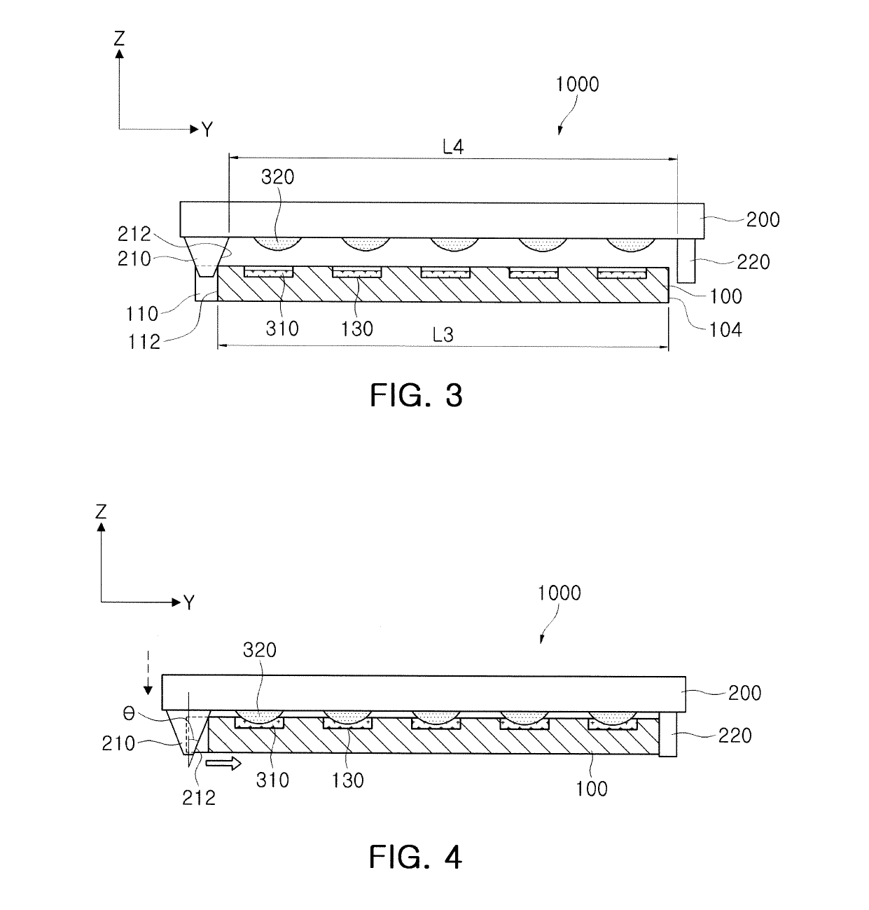

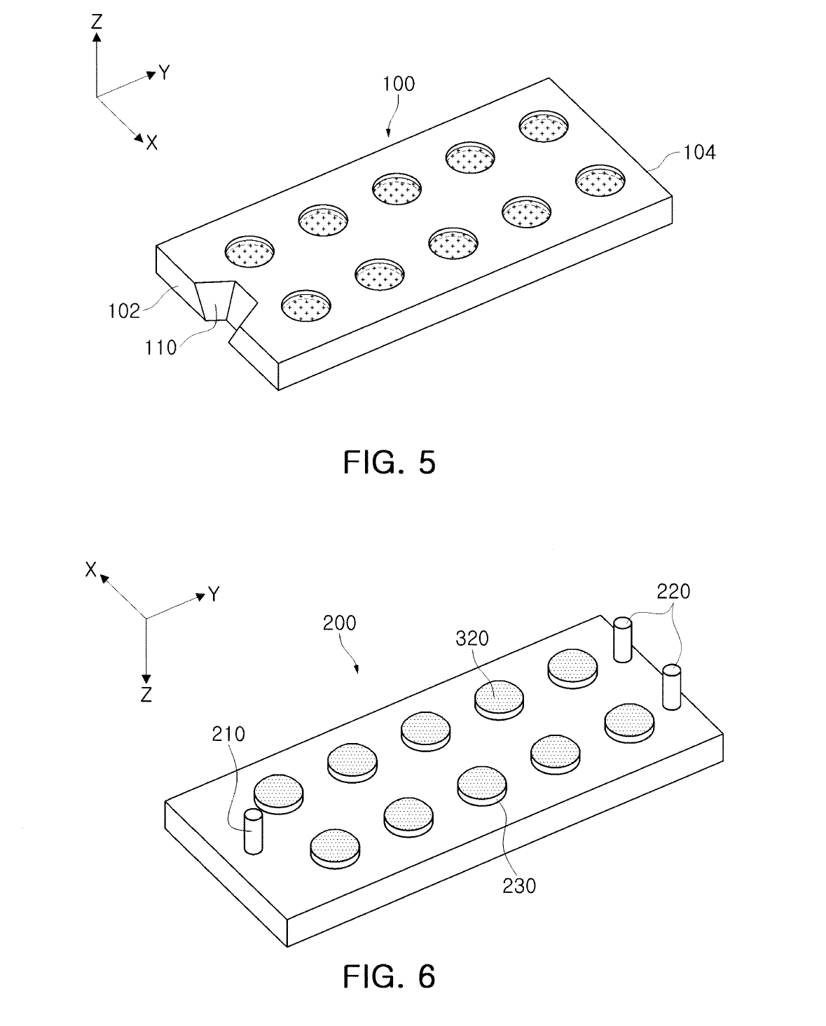

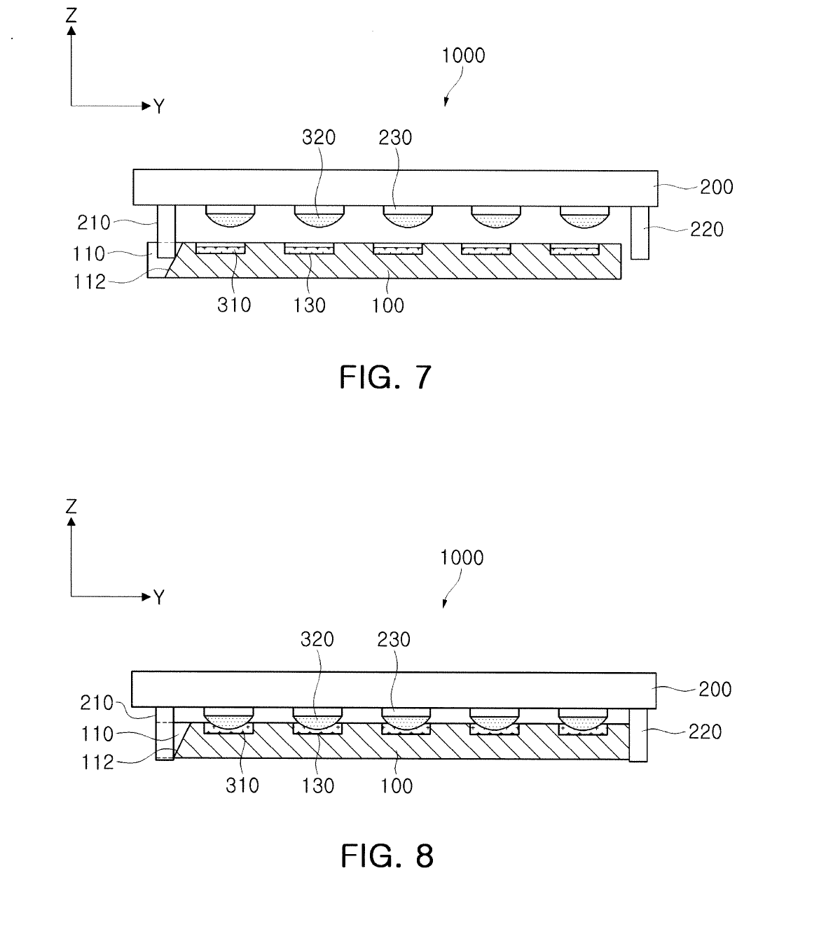

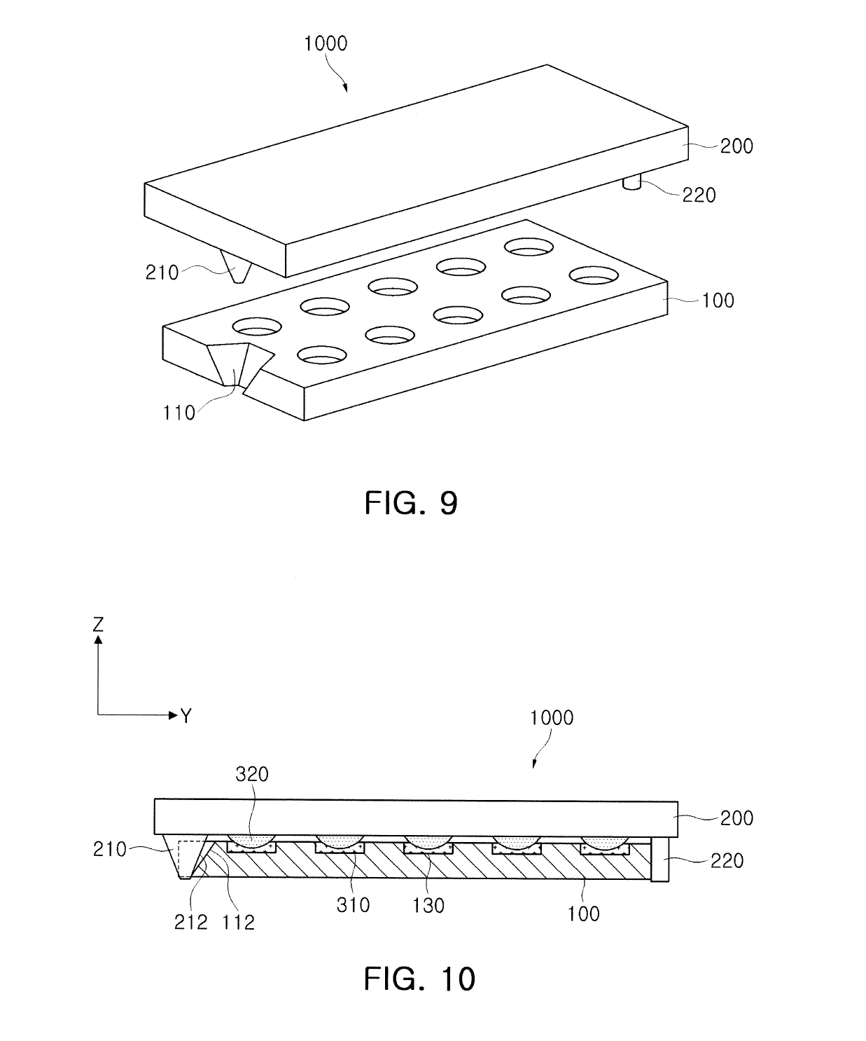

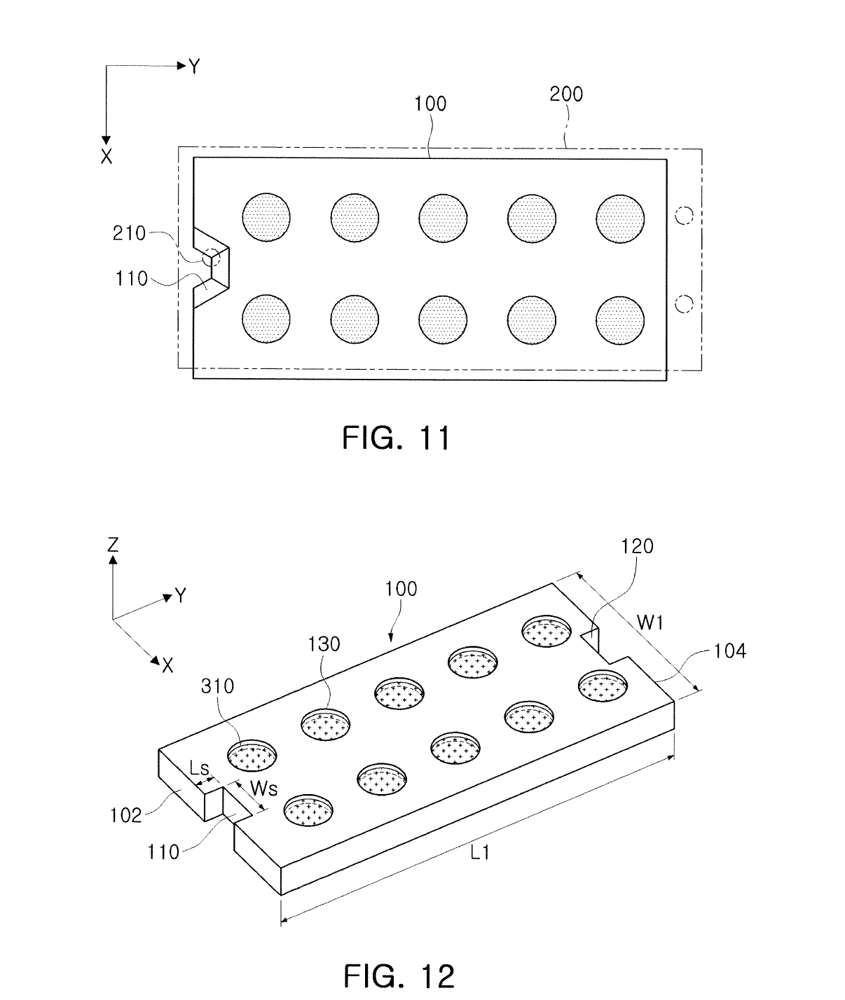

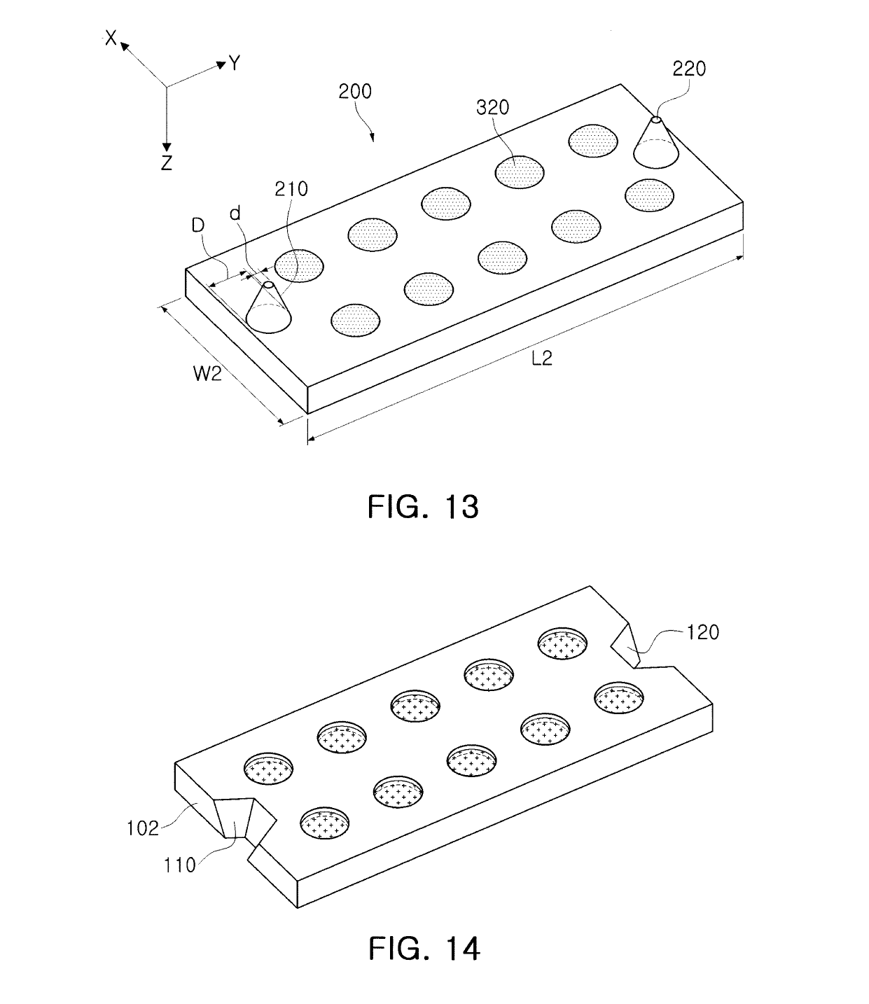

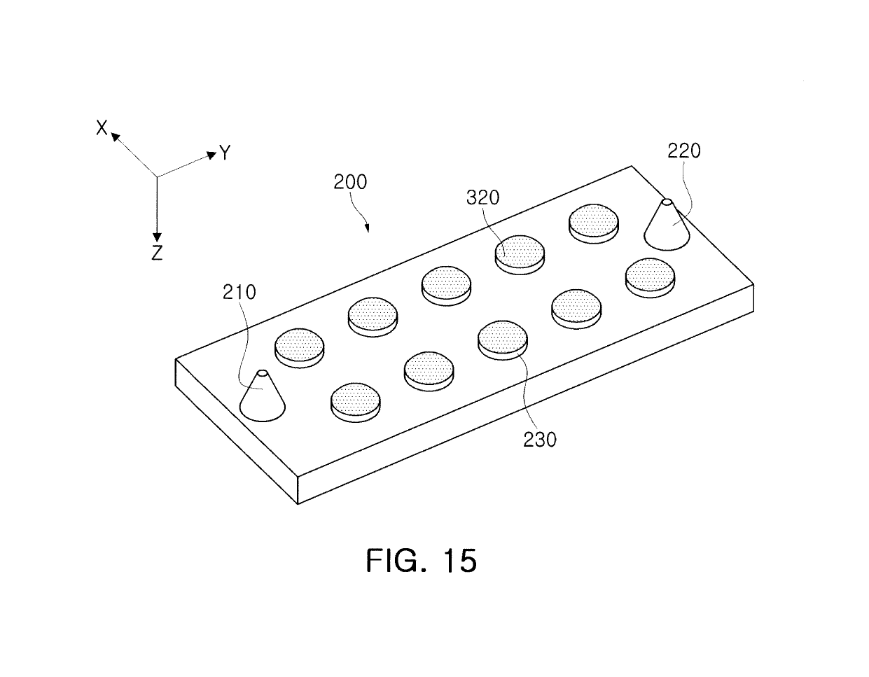

FIGS. 1 and 2 are perspective views of first and second substrates according to a first embodiment of the present invention. FIGS. 3 and 4 are cross-sectional views showing a process of coupling the first and second substrates illustrated in FIGS. 1 and 2. FIGS. 5 and 6 are perspective views of first and second substrates according to a second embodiment of the present invention. FIGS. 7 and 8 are cross-sectional views showing a process of coupling the first and second substrates illustrated in FIGS. 5 and 6. FIG. 9 is a perspective view of first and second substrates according to a third embodiment of the present invention. FIGS. 10 and 11 are a cross-sectional view and a plan view showing a process of coupling the first and second substrates illustrated in FIG. 9. FIGS. 12 and 13 are perspective views of first and second substrates according to a fourth embodiment of the present invention. FIGS. 14 and 15 are perspective views of first and second substrates according to a fifth embodiment of the present invention.

A bio-chip according to a first embodiment of the present invention will be described with reference to FIGS. 1 through 4.

A bio-chip 1000 according to the present embodiment may include a first substrate 100 and a second substrate 200.

As shown in FIG. 1, the first substrate 100 may have a relatively thin plate shape. In detail, the first substrate 100 may have a rectangular shape having a length of L1 and a width of W1. The first substrate 100 having such a shape may be used as a meta-chip accommodating a first material 310 (e.g., a reagent). To this end, the first substrate 100 may include a plurality of accommodation recesses 130. The accommodation recesses 130 may be formed at regular intervals along X axis and Y axis.

The first substrate 100 may be formed of a plastic material. The first substrate 100 formed of a plastic material may be mass-produced through molding, so a fabrication unit cost thereof may be reduced in comparison to a bio-chip formed of a glass material. In addition, the first substrate 100 formed of a plastic material is relatively lightweight and has relatively low brittleness, which, thus, may be easily handled and have a low damage generation rate according to careless handling.

The first substrate 100 may include a first end surface 102 and a second end surface 104. Here, a first recess 110 extending in a Y-axis direction may be formed in the first end surface 102 or the second end surface 104.

The first recess 110 may have a shape having a quadrangular section. Here, the quadrangular section may have a width of Ws and a length of Ls. However, the first recess 110 may be formed to have a section having any other shape than the quadrangular section. For example, the first recess 110 may have a section having a triangular, pentagonal, an octagonal shape.

As shown in FIG. 2, the second substrate 200 may have a shape of a relatively thin plate. The second substrate 200 may have a rectangular shape having a length of L2 and a width of W2. Here, the length L2 and the width W2 may be equal to or greater than the length L1 and the width W1 of the first substrate 100. The second substrate 200 having such a shape may be used as a data chip to which a second material 320 (e.g., a bio-material) is attached.

Like the first substrate 100, the second substrate 200 may be formed of a plastic material. However, in consideration of a bio-material, or the like, attached to the second substrate 200, the second substrate 200 may be formed of a material different from that of the first substrate 100. Also, when the second substrate 200 is used as a data chip, the second substrate 200 may be formed of a hydrophilic material allowing a bio-material to be easily attached thereto. In detail, a portion of the second substrate 200 to which a bio-material is to be attached may be coated with a hydrophilic material. However, a portion of the second substrate 200 to which a bio-material is not attached may be formed of a hydrophobic material or coated with a hydrophobic material.

The second substrate 200 may include a first coupling pillar 210 and a second coupling pillar 220. The first coupling pillar 210 may be formed at a position corresponding to the first recess 110 of the first substrate 100, and the second coupling pillar 220 may be formed at position in surface-contact with the second end surface 104 of the first substrate 100.

The first coupling pillar 210 may have a conical shape, a pyramidal shape, a truncated conical shape, or a truncated pyramidal shape. In the present embodiment, the first coupling pillar 210 may have a truncated conical shape having a maximum diameter of D and a minimum diameter of d. Here, the maximum diameter D of the first coupling pillar 210 may be greater than the width Ws and the length Ls of the first recess 11. This relational condition allows the first coupling pillar 210 and the first recess 110 to be in point contact, thereby calibrating a coupling position of the first substrate 100 and the second substrate 200.

A process of coupling the bio-chip 1000 configured thusly will be described with reference to FIGS. 3 and 4.

As shown in FIGS. 3 and 4, the first substrate 100 and the second substrate 200 may be coupled such that the second substrate 200 is mounted on the first substrate 100.

Namely, the first substrate 100 may be fixed in a state of accommodating the first material 310 in the accommodation recess 130 formed therein, and the second substrate 200 may be moved down to the first substrate 100 (in a Z-axis direction based on FIG. 3) so as to be coupled to the first substrate 100.

Here, since the first coupling pillar 210 has a conical shape with a sloped face 212, while moving down, the second substrate 200 according to the present embodiment may be aligned with a relative position changed thereof with respect to the first substrate 100.

Meanwhile, the second coupling pillar 220 may be in contact with the second end surface 104 of the first substrate 100 to serve to limit a movement direction of the second substrate 200.

For reference, a distance L3 from an inner face 112 of the first recess 110 of the first substrate 100 to the second end surface 104 thereof may be greater than a distance L4 from an end of the first coupling pillar 210 of the second substrate 200 to an end of the second coupling pillar 220. With this condition, the sloped face 212 of the first coupling pillar 210 and the inner face 112 of the first recess 110 may be brought into contact.

As for the first substrate 100 and the second substrate 200 configured thusly, the second substrate 200 may be moved along the sloped face 212 of the first coupling pillar 210 and a position thereof in the Y-axis direction may be determined. Thus, according to the present embodiment, the coupling position of the first substrate 100 and the second substrate 200 may be precisely regulated by adjusting an angle (8) of the sloped face 212 of the first coupling pillar 210.

Thus, according to the present embodiment, although the first substrate 100 and the second substrate 200 are fabricated according to a method having relatively low precision, the coupling precision of the first substrate 100 and the second substrate 200 may be enhanced.

Other embodiments of the present invention will be described below.

A bio-chip according to a second embodiment of the present invention will be described with reference to FIGS. 5 through 8.

The bio-chip 1000 according to the second embodiment of the present invention may be discriminated from that of the first embodiment, in the shape of the first recess 110 and the first coupling pillar 210. Also, the second substrate 200 according to the second embodiment may have protrusions 230.

In the second embodiment, the first recess 110 may have a sloped face as shown in FIG. 5. Namely, the first recess 110 may have such a shape that a sectional area thereof is gradually reduced in the −Z-axis direction based on FIG. 5.

In the second embodiment, the first coupling pillar 210 may have the same cylindrical shape as that of the second coupling pillar 220.

In the present embodiment configured as described above, as shown in FIGS. 7 and 8, the position may be aligned as the first coupling pillar 210 is moved along the inner face 112 of the first recess 110 in the −Y-axis direction.

Meanwhile, the second substrate 200 may have a plurality of protrusions 230. The protrusions 230 may be formed at positions corresponding to the accommodation recesses 130 of the first substrate 100, and may be coated with a hydrophilic material to allow the second material 320 to be easily attached thereto. Alternatively, the protrusions 230 may be surface-processed to be rough to allow the second material 320 to be easily attached thereto.

A bio-chip according to a third embodiment of the present invention will be described with reference to FIGS. 9 through 11.

The bio-chip 1000 according to the third embodiment of the present invention may be discriminated from that of the first embodiment, in the shape of the first recess 110 and the first coupling pillar 210.

In the third embodiment, the first recess 110 may have the same shape as that of the first recess according to the second embodiment, and the first coupling pillar 210 may have the same shape as that of the first coupling pillar according to the first embodiment.

In the bio-chip 1000 configured in this manner, as shown in FIGS. 10 and 11, the first coupling pillar 210 and the first recess 110 may be in point contact. Here, the first substrate 100 and the second substrate 220 are coupled and moved in the Z-axis direction and, at the same time, moved in the X-Y planar direction, whereby the coupling position of the first substrate 100 and the second substrate 200 may be naturally aligned.

Accordingly, the present embodiment may be useful when a fabrication tolerance of the first substrate 100 and the second substrate 200 is relatively great.

A bio-chip according to a fourth embodiment of the present invention will be described with reference to FIGS. 12 and 13.

The bio-chip 1000 according to the fourth embodiment of the present invention may be discriminated from the foregoing embodiments, in that it further includes a second recess 120. Also, this embodiment may be discriminated from the foregoing embodiments, in that both of the first coupling pillar 210 and the second coupling pillar 220 may have a conical shape, pyramidal shape, a truncated conical shape, or truncated pyramidal shape.

Namely, in the present embodiment, the first substrate 100 may have the first recess 110 on the first end surface 102 and the second recess 120 on the second end surface 104.

Also, the second substrate 200 may include the first coupling pillar 210 formed at a position corresponding to the first recess 110 and having a conical shape, pyramidal shape, a truncated conical shape, or truncated pyramidal shape, and the second coupling pillar 220 formed at a position corresponding to the second recess 120 and having a conical shape, pyramidal shape, a truncated conical shape, or truncated pyramidal shape.

In the present embodiment configured as described above, the first coupling pillar 210 and the second coupling pillar 220 may be in contact with the inner faces of the first recess 110 and the second recess 120. Here, since the first substrate 100 and the second substrate 200 are moved in the X-Y planar direction at the same time when they are coupled in the Z-axis direction, whereby the first substrate 100 and the second substrate 200 may be precisely coupled.

A bio-chip according to a fifth embodiment of the present invention will be described with reference to FIGS. 14 and 15.

The bio-chip 1000 according to the fifth embodiment of the present invention may be discriminated from that of the fourth embodiment, in the shape of the recesses 110 and 120. For example, the recesses 110 and 120 according to the fifth embodiment of the present invention may have the same shape as that of the first recess according to the second embodiment of the present invention.

Such a configuration includes the strengths of the second and fourth embodiments of the present invention, coupling precision of the first substrate 100 and the second substrate 200 may be enhanced.

Meanwhile, in the foregoing embodiment, it is described and illustrated that one first recess 110 is formed in the surface of the first substrate 100 and one first coupling pillar 210 is formed on the second substrate 200, but the number of first recesses 110 and the number of first coupling pillars 210 corresponding thereto may be changed according to the size and purpose of the substrates 100 and 200.

As set forth above, according to embodiments of the invention, the first substrate (or meta-chip) and the second substrate (or data chip) may be precisely coupled by coupling the recesses and coupling pillars.

Thus, according to an embodiment of the present invention, inspection reliability of the bio-chip including the first substrate (or meta-chip) and the second substrate (or data chip) may be enhanced.

Also, since the coupling position of the first and second substrates is gradually calibrated, the first and second substrates may be precisely coupled although there is a tolerance in the shapes of the first and second substrates.

Thus, the first and second substrates may be fabricated through injection molding having relatively low molding precision, and accordingly, a fabrication unit cost of the bio-chip may be reduced.

While the present invention has been shown and described in connection with the embodiments, it will be apparent to those skilled in the art that modifications and variations can be made without departing from the spirit and scope of the invention as defined by the appended claims.

1. A bio-chip comprising:
a first substrate including a first recess formed in a first end surface thereof, the first substrate accommodating a first material selected from a bio-material or a medicine; and
a second substrate including a first coupling pillar inserted into the first recess and a second coupling pillar in contact with a second end surface opposed to the first end surface, the second substrate accommodating a second material selected from a bio-material or a medicine.

2. The bio-chip of claim 1, wherein the first coupling pillar has a conical shape, a pyramidal shape, a truncated conical shape, or a truncated pyramidal shape.

3. The bio-chip of claim 1, wherein the second coupling pillar has a conical shape, a pyramidal shape, a truncated conical shape, or a truncated pyramidal shape.

4. The bio-chip of claim 1, wherein the first recess has a section gradually reduced in a thicknesswise direction of the first substrate.

5. (canceled)

6. The bio-chip of claim 1, wherein the first recess gradually narrows from the first end surface toward the second end surface.

7. The bio-chip of claim 1, wherein a distance from a radius center of the first recess to the second end surface is greater than a distance from the first coupling pillar to the second coupling pillar.

8. The bio-chip of claim 1, wherein the second end surface has a second recess formed therein, and the second coupling pillar is inserted into the second recess.

9. The bio-chip of claim 7, wherein the second recess has a section gradually reduced in the thicknesswise direction of the first substrate.

10. The bio-chip of claim 7, wherein the second recess gradually narrows from the second end surface toward the first end surface.

11. The bio-chip of claim 7, wherein a distance from the radius center of the first recess to a radius center of the second recess is greater than a distance from the first coupling pillar to the second coupling pillar.

12. The bio-chip of claim 1, wherein the first substrate includes an accommodation recess accommodating the bio-material or the medicine.

13. The bio-chip of claim 1, wherein the second substrate includes a protrusion for fixing the bio-material or the medicine thereto.

14. The bio-chip of claim 1, wherein the first or second substrate is formed of a plastic material.

15. The bio-chip of claim 1, wherein the first or second substrate is formed of a hydrophilic material.

16. The bio-chip of claim 1, wherein the first or second substrate is formed of a hydrophobic material.
